(19) United States
(12) Patent Application Publication
(10) Pub. No.: US 2019/0250675 A1
(43) Pub. Date: Aug. 15, 2019

(54) MULTIAXIAL HINGE MODULE AND ELECTRONIC DEVICE

(71) Applicants: Che-Hsien Lin, Taipei City (TW); Che-Hsien Chu, Taipei City (TW)

(72) Inventors: Che-Hsien Lin, Taipei City (TW); Che-Hsien Chu, Taipei City (TW)

(73) Assignee: COMPAL ELECTRONICS, INC., Taipei City (TW)

(21) Appl. No.: 16/274,257

(22) Filed: Mar. 1, 2019

Related U.S. Application Data
(60) Provisional application No. 62/630,206, filed on Feb. 13, 2018.

(51) Int. Cl. G06F 1/16; E05D 3/14; E05D 11/08; E05D 11/00

(52) U.S. Cl. CPC G06F 1/1681; E05D 3/14; G06F 1/1616; E05D 11/0054; E05Y 2900/606; E05D 11/082

(57) ABSTRACT

A multiaxial hinge module including a first bracket, a second bracket, a first rotating shaft, a second rotating shaft, a third rotating shaft, a fourth rotating shaft, a first torque member, and a second torque member is provided. The first and the second rotating shafts are disposed in a first and a second axle holes of the first bracket respectively, the third and the fourth rotating shafts are disposed in a third and a fourth axle holes of the second bracket respectively. The first, the second, the third, and the fourth rotating shafts and the axle holes corresponding thereto are arranged in a multiaxial parallel manner. The first and the third rotating shafts are pivoted to the first torque member respectively. The second and the fourth rotating shafts are pivoted to the first torque member respectively. An electronic device is also provided.

### CROSS-REFERENCE TO RELATED APPLICATION

This application claims the priority benefit of U.S. provisional application Ser. No. 62/630,206, filed on Feb. 13, 2018. The entirety of the above-mentioned patent application is hereby incorporated by reference herein and made a part of this specification.

### BACKGROUND OF THE INVENTION

### Field of the Invention

The invention is related to a multiaxial hinge module and an electronic device.

### Description of Related Art

Notebook computers have been developed to replace desktop computers for a user to carry it more convenient. The notebook computer includes a first body having a display screen, a second body having a system, and a hinge structure configured to connect the first body and the second body. A hinge structure with dual axes are now adopted for a notebook computer so as to enable the first body and the second body to be unfolded in a larger angle.

Nowadays, related components of the notebook computer are still needed to be further reduced in shape so as to meet the trend of light and thin design. However, the hinge module configured to support the bodies of the notebook computer cannot be reduced due to the need for maintaining certain torque. That is, if the hinge module is reduced with the bodies of the notebook computer, the torque of the hinge module may be too low to support the bodies, and thus it has being a barrier for the light and thin design of the notebook computer.

### SUMMARY OF THE INVENTION

The invention provides a multiaxial hinge module and an electronic device applied thereof. Therefore, when bodies of the electronic device are folded or unfolded, the stress applied to each of a rotating shaft is effectively reduced by distracting torque.

The multiaxial hinge module of the invention includes a first bracket, a second bracket, a first rotating shaft, a second rotating shaft, a third rotating shaft, a fourth rotating shaft, a first torque member, and a second torque member. The first rotating shaft and the second rotating shaft are disposed in a first axle hole and a second axle hole of the first bracket respectively. The third rotating shaft and the fourth rotating shaft are disposed in a third axle hole and a fourth axle hole of the second bracket respectively. The first rotating shaft, the second rotating shaft, the third rotating shaft, and the fourth rotating shaft and the first axle hole, the second axle hole, the third axle hole, and the fourth axle hole are arranged in a multiaxial parallel manner. The first rotating shaft and the third rotating shaft are pivoted to the first torque member respectively. The second rotating shaft and the fourth rotating shaft are pivoted to the second torque member respectively.

An electronic device of the invention includes a first body, a second body, and at least one multiaxial hinge module. A multiaxial hinge module is connected to the first body and the second body. The first body and the second body rotate relatively to be folded or unfolded by the at least one multiaxial hinge module. The multiaxial hinge module includes a first bracket, a second bracket, a first rotating shaft, a second rotating shaft, a third rotating shaft, a fourth rotating shaft, a first torque member, and a second torque member. The first rotating shaft and the second rotating shaft are disposed in a first axle hole and a second axle hole of the first bracket. The third rotating shaft and the fourth rotating shaft are disposed in a third axle hole and a fourth axle hole of the second bracket. The first rotating shaft, the second rotating shaft, the third rotating shaft, and the fourth rotating shaft and the first axle hole, the second axle hole, the third axle hole, and the fourth axle hole are arranged in a multiaxial parallel manner. The first rotating shaft and the third rotating shaft are pivoted to the first torque member respectively. The second rotating shaft and the fourth rotating shaft are pivoted to the second torque member respectively.

Based on the above, the multiaxial hinge module is connected to different bodies of the electronic device via a plurality of rotating shafts arranged in parallel and staggered, so that the plurality of rotating shafts share the stress load of the single rotating shaft while the body being rotated. Furthermore, a portion of the rotating shafts of the multiaxial hinge module are pivoted to one torque member, and another portion of the rotating shafts of the multiaxial hinge module are pivoted to another torque member. In this way, in terms of the multiaxial hinge module, except of the stress load being dispersed via the different torque members while the multiaxial hinge module being rotated, the plurality of rotating shafts are linked to each other by the torque members, and the first body and second body thus successfully being rotated to be folded or unfolded simultaneously. Accordingly, the applied stress load of each of the rotating shafts is lowered, the shape of the rotating shafts and related components thereof are reduced, and the multiaxial hinge module and the electronic device thus have a light and thin appearance.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 is a schematic diagram of an electronic device according to an embodiment of the invention.

FIG. 2A is a schematic diagram of a multiaxial hinge module of FIG. 1.

FIG. 2B is an exploded view of the multiaxial hinge module of FIG. 2A.

FIG. 3A to FIG. 3D illustrate side views of the multiaxial hinge module in different states.

FIG. 4A is a schematic diagram of an electronic device according to another embodiment of the invention.

FIG. 4B is an exploded view of the multiaxial hinge module of FIG. 4A.

FIG. 4C is a sectional view of the multiaxial hinge module of FIG. 4A.

FIG. 5A is a schematic diagram of an electronic device according to another embodiment of the invention.

FIG. 5B is an exploded view of the multiaxial hinge module of FIG. 5A.

FIG. 5C is a side view of the multiaxial hinge module of FIG. 5A.

FIG. 6 is a schematic diagram of an electronic device according to another embodiment of the invention.

### DESCRIPTION OF THE EMBODIMENTS

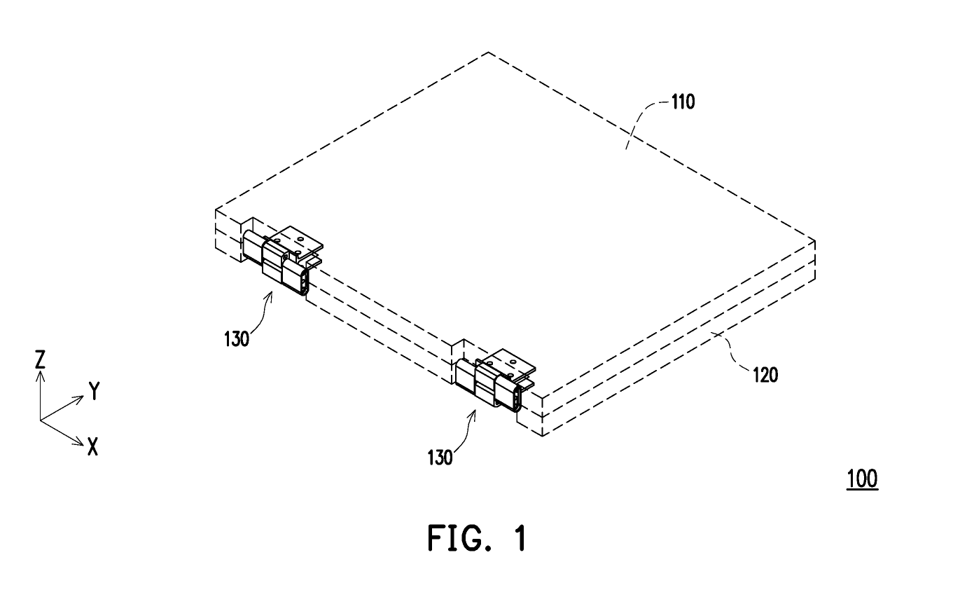

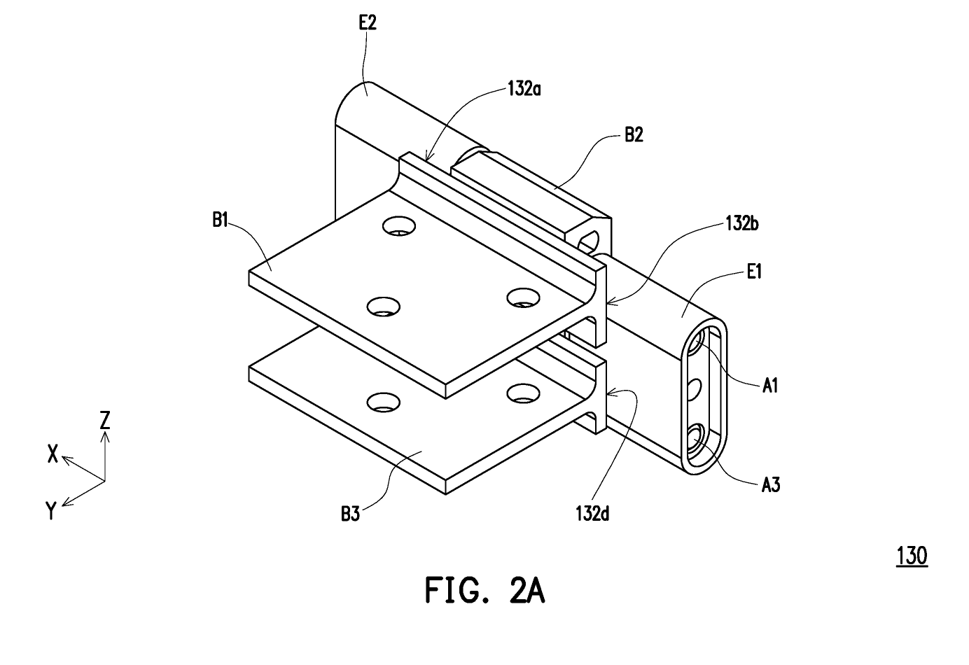

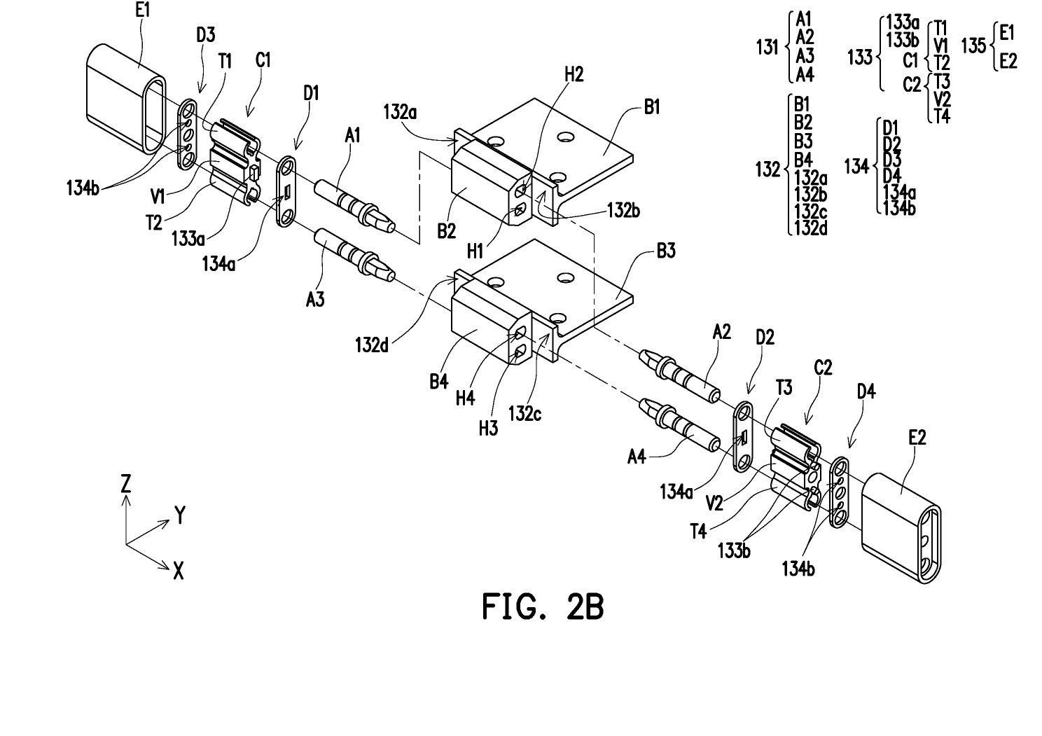

FIG. 1 is a schematic diagram of an electronic device according to an embodiment of the invention. FIG. 2A is a schematic diagram of a multiaxial hinge module of FIG. 1. A Cartesian coordinate system X-Y-Z is provided here for easier component descriptions. Please refer to FIG. 1 and FIG. 2A at the same time. In this embodiment, an electronic device 100 is, for example, a notebook computer, which includes a first body 110 (for example, a display screen), a second body 120 (for example, a system host), and at least one multiaxial hinge module 130. Two multiaxial hinge modules 130 are illustrated as an example of this embodiment, and the two multiaxial hinge modules 130 are in symmetrical configuration relative to the centerline of the first body 110 or the second body 120. The multiaxial hinge module 130 is connected to the same side of the first body 110 and the second body 120, and the two multiaxial hinge modules 130 are independent from each other. The first body 110 and the second body 120 thus rotate relatively to be folded or unfolded about the X-axis via the multiaxial hinge module 130.

FIG. 2B is an exploded view of the multiaxial hinge module of FIG. 2A. Please refer to FIG. 2A and FIG. 2B at the same time. In this embodiment, the multiaxial hinge module 130 includes a rotating shaft assembly 131, a bracket assembly 132, a torque assembly 133, a position-limiting assembly 134, and a housing 135. The rotating shaft assembly 131 includes a first rotating shaft A1, a second rotating shaft A2, a third rotating shaft A3, and a fourth rotating shaft A4. The bracket assembly 132 includes a first bracket B1, and a second bracket B3. The first bracket B1 is assembled to the first body 110. The second bracket B3 is assembled to the second body 120. The first rotating shaft A1 and the second rotating shaft A2 are disposed in a first axle hole H1 and a second axle hole H2 of the first bracket B1 respectively. The third rotating shaft A3 and the fourth rotating shaft A4 are disposed in a third axle hole H3 and a fourth axle hole H4 of the second bracket B3 respectively. The torque assembly 133 includes a first torque member C1 and a second torque member C2. The first rotating shaft A1 and the third rotating shaft A3 are pivoted to the first torque member C1 respectively, and the required torque is provided by the first torque member C1 while the first rotating shaft A1 and the third rotating shaft A3 rotating. The second rotating shaft A2 and the fourth rotating shaft A4 are pivoted to the second torque member C2 respectively, and the required torque is provided by the second torque member C2 while the second rotating shaft A2 and the fourth rotating shaft A4 rotating. As such, a multiaxial parallel linking mechanism is formed by the bracket assembly 132, the rotating shaft assembly 131, and the torque assembly 133. Apart from providing the required torque while the rotating shaft assembly 131 rotating so as to support the first body 110 or the second body 120, the torque assembly 133 is further applied as a linking member between the rotating shaft assembly 131 to ensure that the first body 110 and the second body 120 are rotated about the X-axis to be folded or unfolded simultaneously by the multiaxial hinge module 130.

In this embodiment, the first rotating shaft A1 and the first axle hole H1 are coaxial with each other, the second rotating shaft A2 and the second axle hole H2 are coaxial with each other, the third rotating shaft A3 and third axle hole H3 are coaxial with each other, and the fourth rotating shaft A4 and the fourth axle hole H4 are coaxial with each other, wherein the above shafts and axle holes are extended along the X-axis respectively, parallel to each other in an interleaving arrangement, and connected between the first bracket B1 and the second bracket B3 by the torque assembly 133. Furthermore, the four rotating shafts A1-A4 (four axle holes H1-H4) are parallel to the X-axis respectively and different from each other. In addition, during the rotation process, the four rotating shafts A1-A4 (the four axle holes H1-H4) maintain their different and non-coincident states on the X-axis.

Moreover, each of the first torque member C1 and the second torque member C2 has different torque portions T1, T3, T2, T4 and middle portions V1, V2 located between the different torque portions. The first rotating shaft A1, the second rotating shaft A2, the third rotating shaft A3, and the fourth rotating shaft A4 are pivoted to the torque portions T1, T3, T2, T4 respectively. In addition, it should be noted that, to avoid the torques of the different rotating shafts affected with each other during the rotating process, which results in a user having poor operation experience, in this embodiment, torque transmission between the different torque portions T1, T2 is spaced apart and blocked by the middle portion V1, and torque transmission between the different torque portions T3, T4 is spaced apart and blocked by the middle portion V2. In this embodiment, the middle portions V1, V2 are substantially non-deformable solid structures, which are different from the deformable torque portions T1-T4. Therefore, the torque on the torque portions T1-T4 may thus be blocked without affecting each other.

It should be illustrated here that in the multiaxial hinge module 130 of this embodiment, the related structures of a position-limiting assembly 134 and the torque assembly 133 are in symmetrical configuration with respect to the Y-axis. Therefore, in FIG. 2B, the components on the side failed to be illustrated due to the viewing angle may take the other side as the identification basis, and the portion in symmetrical configuration have the same reference numeral at the same time as references.

In this embodiment, the position-limiting assembly 134 includes a position-limiting member D1, a second position-limiting member D2, a third position-limiting portion D3, and a fourth position-limiting member D4, while the housing 135 includes a first housing E1, and a second housing E2. The position-limiting member D1 has an opening 134a, and the middle portion V1 of the first torque member C1 has a protruding portion 133a. The protruding portion 133a is locked to the opening 134a, so that the position-limiting member D1 is stacked on the torque member C1. The third position-limiting portion D3 has at least one opening (two openings 134b are illustrated here). The middle portion V1 of the first torque member C1 further has at least one protruding portion (referring to the second torque member C2 on the right side of FIG. 2B, which has two protruding portions 133b). The protruding portion 133b is correspondingly locked to the opening 134b, so that the third position-limiting portion D3 is stacked on the first torque member C1.

Likewise, please refer to the right side of FIG. 2B. The second position-limiting member D2 has the opening 134a, and the middle portion V2 of the second torque member C2 has a protruding portion (referring to an example of the first torque member C1 on the left side of FIG. 2B, which has the protruding portion 133a). The protruding portion is locked to the opening 134a, so that second position-limiting member D2 is stacked on the second torque member C2. The fourth position-limiting member D4 has at least one opening (an example of two openings 134b illustrated here), and the middle portion V2 of the second torque member C2 further has at least one protruding portion (an example of two protruding portion 133b illustrated here). The protruding portion 133b is correspondingly locked to the opening 134b, so that the fourth position-limiting member D4 is stacked on the second torque member C2.

Accordingly, the first torque member D1 and the third torque member D3 are stacked on opposite two sides of the first torque member C1 along the X-axis. It is equivalent that the first torque member C1 is locked into the first housing E1 after being held by the position-limiting member D1 and the third position-limiting portion D3. In this way, the middle portion V1 of the first torque member C1, the position-limiting member D1, the third position-limiting portion D3 are formed as a common structure to be locked into the first housing E1, and a further block effect is provided because of the torque influence between the aforementioned torque portion T1 and torque portion T2. The same effect also occurs to the second torque member C2, the second position-limiting member D2, the fourth position-limiting member D4, and the second housing E2 on the right side of FIG. 2B, which may not be repeated herein.

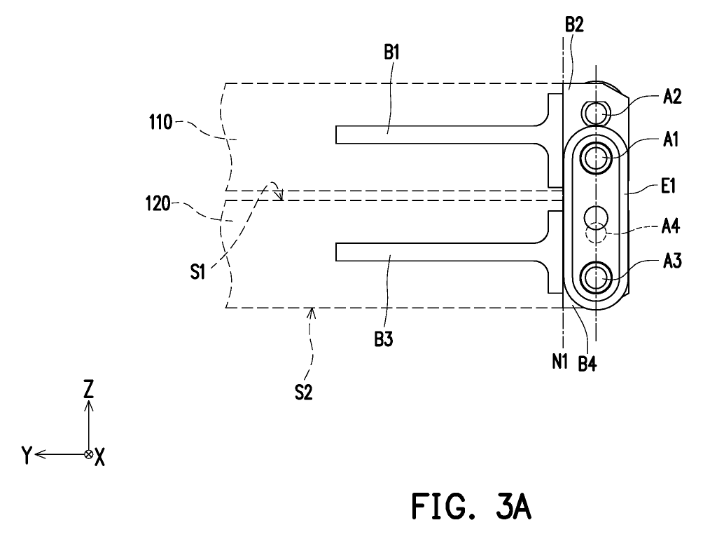

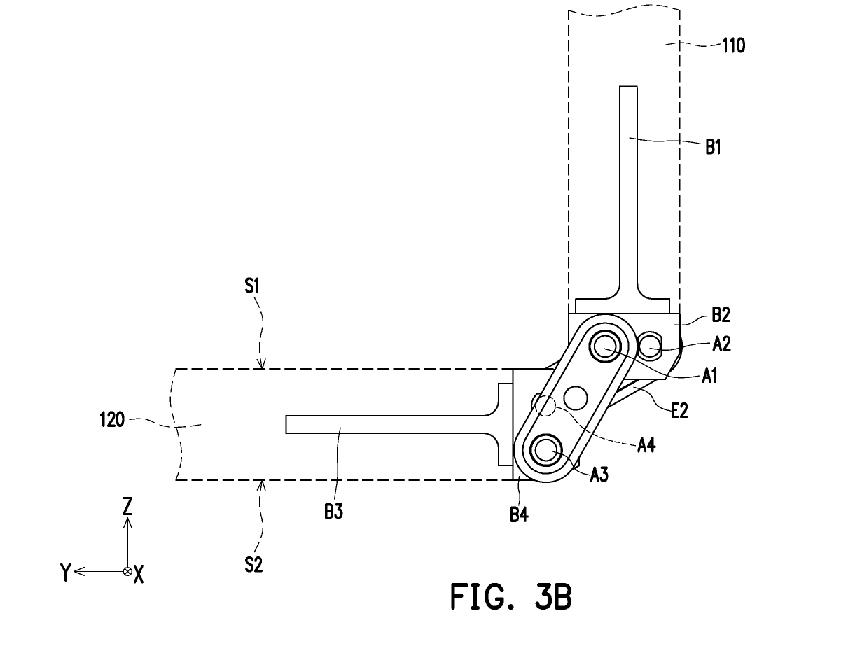

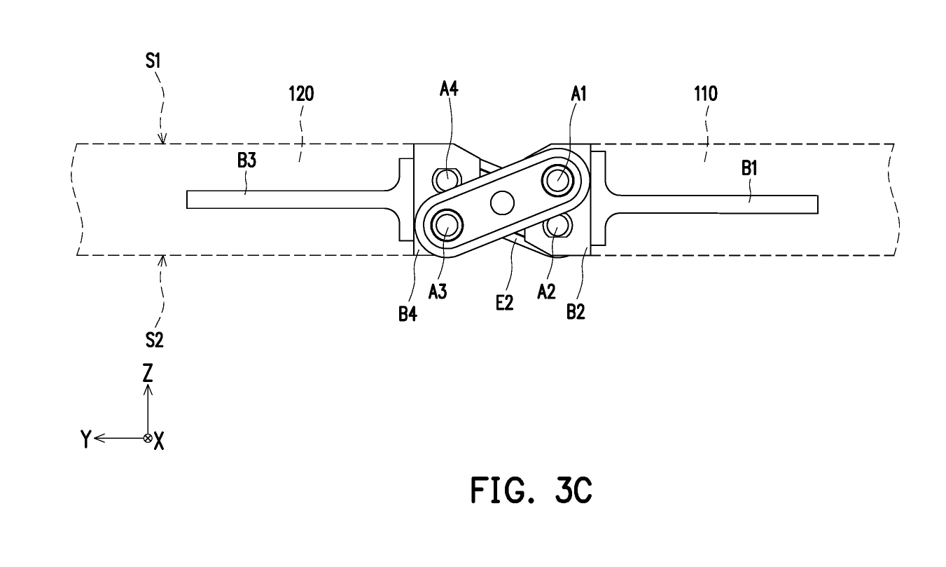

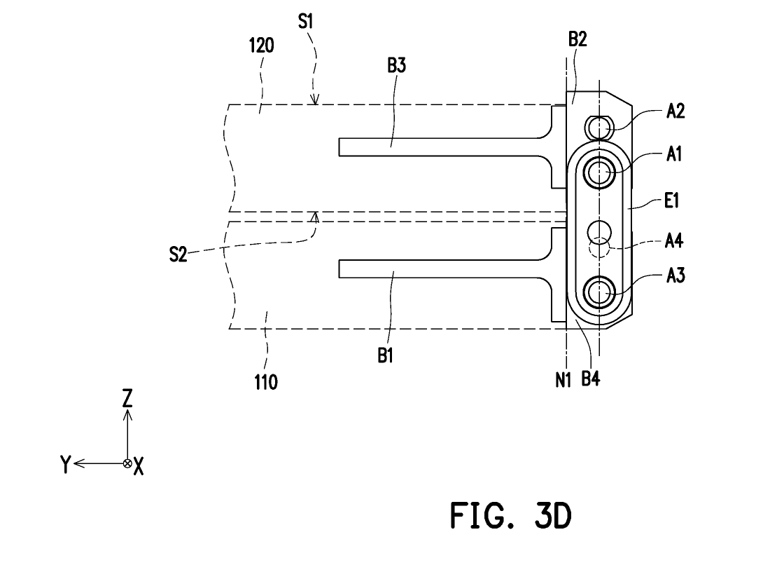

FIG. 3A to FIG. 3D illustrate side views of a multiaxial hinge module in different states. Please refer to FIG. 3A first. The illustrated state of FIG. 3A is the same as the state illustrated in FIG. 1, that is, the first body 110 is stacked on a surface S1 of the second body 120, so that the electronic device 100 is in a folded state (in a state of 0 degree). Then, as illustrated in FIG. 3B (in a state of 90 degrees) and FIG. 3C (in a state of 180 degrees), the user applies an external force to the first body 110 or/and the second body 120 to rotate and unfold the first body 110 or/and the second body 120. Because of the linking deposition of the rotating shaft assembly 131 and the torque assembly 133, the multiaxial hinge module 130 leads to the first body 110 and the second body 120 rotating simultaneously till the state of 360 degree as illustrated in FIG. 3D. That is, the first body 110 is rotated with respect to the second body 120 and stacked on the surface S2. The surfaces S1, S2 are located on opposite two sides of the second body 120.

Please further refer to FIG. 2B, and compare with FIG. 3A and FIG. 3D. As the aforementioned, a multiaxial linking mechanism is formed by the torque assembly 133 and the rotating shaft assembly 131. In a state as illustrated in FIG. 3A and FIG. 3D, the first rotating shaft A1, the second rotating shaft A2, the third rotating shaft A3, and the fourth rotating shaft A4 are arranged in a straight line. At this time, in terms of the multiaxial linking mechanism, a dead position is formed by the state of being arranged as the straight line. The dead position defined in this embodiment is that the multiaxial linking mechanism has freedoms of different rotation directions at the same time, thus causing instability. That is, there is no specific rotation trend between the rotating shaft assembly 131 and the torque assembly 133 at this time, the normal application of the electronic device 100 is thus being affected due to the possibility of unacceptable movement modes. Accordingly, please refer to FIG. 2B. The first bracket B1 of this embodiment has at least one first stopping surface (two first stopping surfaces 132a, 132billustrated as an example), and a first connecting portion B2. The first connecting portion B2 has the aforementioned first axle hole H1 and the second axle hole H2. The second bracket B3 has at least one second stopping surface (two second stopping surfaces 132c, 132d illustrated as an example) and a second connecting portion B4. The second connecting portion B4 has the aforementioned third axle hole H3 and the fourth axle hole H4. The first rotating shaft A1 and the second rotating shaft A2 are opposite to each other and staggered pivoted to the first axle hole H1 and the second axle hole H2 of the first connecting portion B2. The third rotating shaft A3 and the fourth rotating shaft A4 are opposite to each other and staggered pivoted to the third axle hole H3 and the fourth axle hole H4 of the second connecting portion B4. When the first rotating shaft A1, second rotating shaft A2, the third rotating shaft A3, and the fourth rotating shaft A4 are arranged in the straight line, as illustrated in FIG. 3A or FIG. 3D, the first stopping surfaces 132a, 132b stops at least one of the first torque member C1 and the second torque member C2, the second stopping surface 132c, 132d stops at least one of the second torque member C2 and the first torque member C1, so that each of the first rotating shaft A1, the second rotating shaft A2, the third rotating shaft A3, and the fourth rotating shaft A4 has only one direction to pivot. Here, the straight line is located on a Y-Z plane, and the multiaxial hinge module 130 is rotated about the X-axis.

Furthermore, the first stopping surfaces 132a, 132b of this embodiment are located at opposite two sides of the first connecting portion B2, while the second stopping surfaces 132c, 132d are located at opposite two sides of the second connecting portion B4. Therefore, when the first rotating shaft A1, the second rotating shaft A2, the third rotating shaft A3, and the fourth rotating shaft A4 are arranged in the straight line, the first stopping surfaces 132a, 132b and the second stopping surfaces 132c, 132d are located on the same side of the rotating shaft assembly 131, and stop the torque assembly 133 in the same direction, wherein the direction is orthogonal to the straight line. That is, as illustrated in FIG. 3A, the first stopping surfaces 132a, 132b and the second stopping surfaces 132c, 132d are located on a same plane N1, and face toward the negative Y-axis direction to be in contact with the housing 135 and the torque assembly 133 therein. Accordingly, the aforementioned instability state is overcome. That is, only one direction of pivoting of each of the torque assembly 133 and the rotating shaft assembly 131 is remained, and the unfolding process may only be performed in a clockwise direction as illustrated from FIG. 3A to FIG. 3D. Conversely, in a state illustrated in FIG. 3D, because of the first stopping surfaces 132a, 132b and the second stopping surfaces 132c, 132d, only one direction of pivoting of each of the torque assembly 133 and the rotating shaft assembly 131 is remained, and the folding process may only be performed in a counterclockwise direction as illustrated from FIG. 3D to FIG. 3A.

On the other hand, it is also possible that the electronic device 100 of this embodiment may be in a state of 0 degree illustrated in FIG. 3A or in a state of 360 degree illustrated in FIG. 3D when the aforementioned rotating shafts are arranged in the straight line. The multiaxial linking mechanism at this time has only one direction to pivot because of the stopping. That is, this move effectively prevents the possibility that the rotating shaft is arranged in the straight line and thus interrupts the process during the rotating of folding or unfolding of the electronic device 100 (other states which are not FIG. 3A nor FIG. 3D).

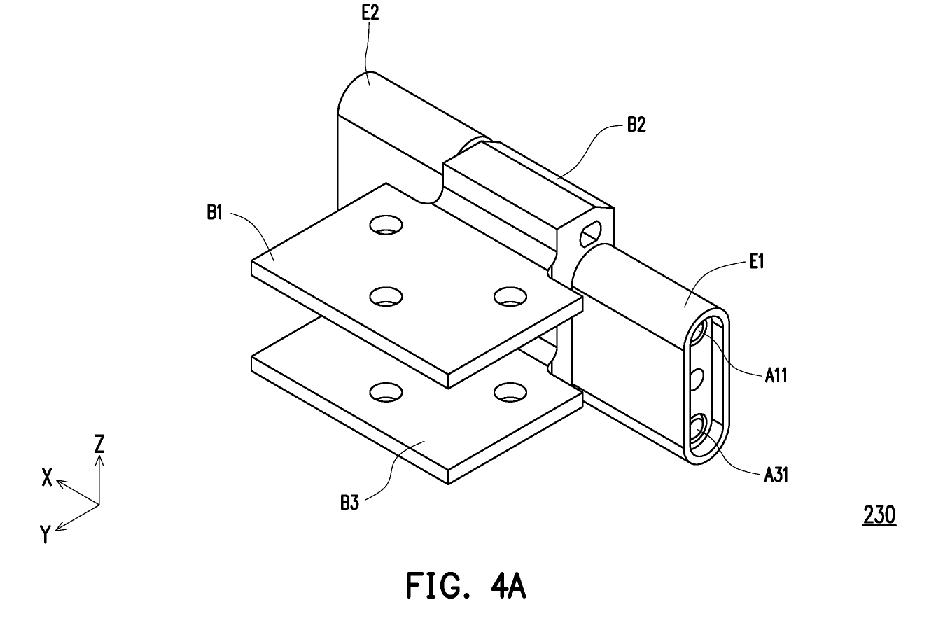

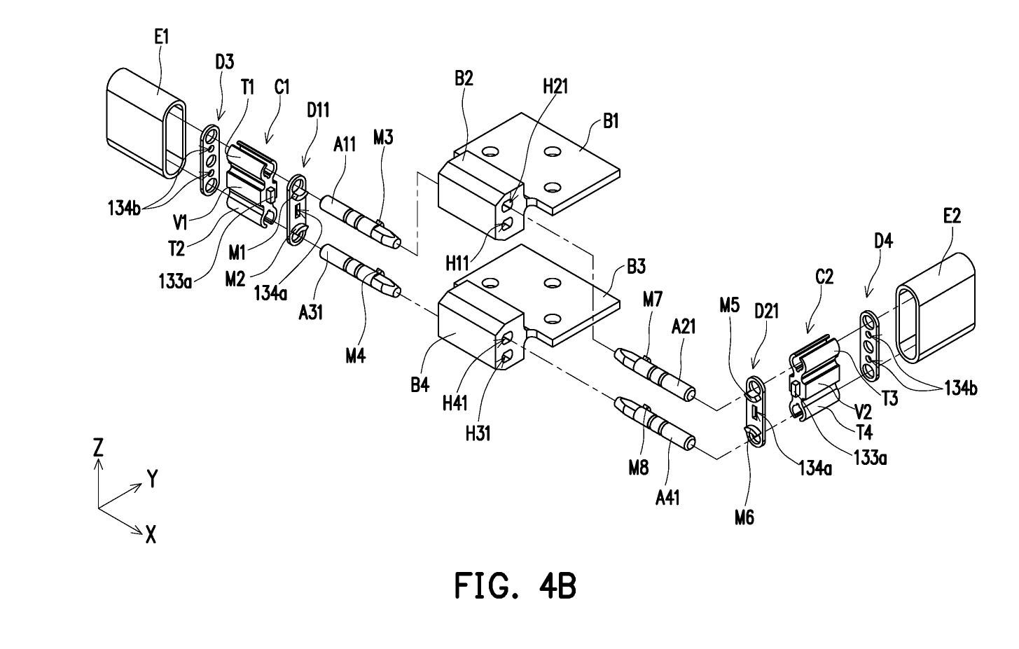

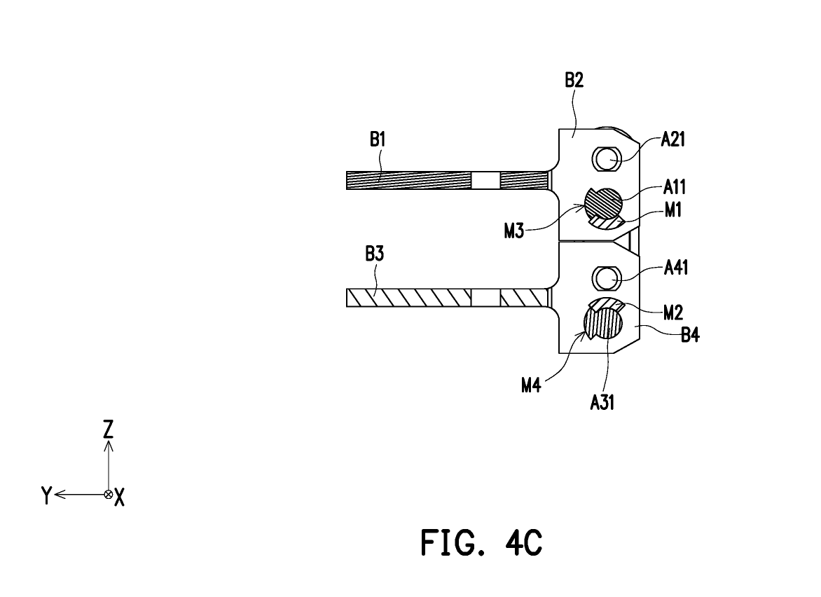

FIG. 4A is a schematic diagram of an electronic device according to another embodiment of the invention. FIG. 4B is an exploded view of the multiaxial hinge module of FIG. 4A. FIG. 4C is a sectional view of the multiaxial hinge module of FIG. 4A. Please refer to FIG. 4A to FIG. 4C at the same time. The members same as the aforementioned embodiments are illustrated as the same reference numeral, and may not be repeated herein. The difference between the present and the aforementioned embodiments is that a multiaxial hinge module 230 includes a position-limiting structure. In addition, the position-limiting structure includes a first position-limiting portion M1 and a second position-limiting portion M2 disposed on a position-limiting member D11, a third position-limiting portion M3 disposed on a first rotating shaft A11, a fourth position-limiting portion M4 disposed on a third rotating shaft A31, a fifth position-limiting portion M5 and a sixth position-limiting portion M6 disposed on a second position-limiting member D21, a seventh position-limiting portion M7 disposed on a second rotating shaft A21, and an eighth position-limiting portion M8 disposed on a fourth rotating shaft A41.

Moreover, the first rotating shaft A11 and the third rotating shaft A31 are pivoted to the position-limiting member D11. Therefore, the first position-limiting portion M1 is in a movement path of the third position-limiting portion M3, and vice versa. Furthermore, the second position-limiting portion M2 is in a movement path of the fourth position-limiting portion M4, and vice versa. Similarly, the second rotating shaft A21 and the fourth rotating shaft A41 are pivoted to the second position-limiting member D21. Therefore, the fifth position-limiting portion M5 is in a movement path of the seventh position-limiting portion M7, and vice versa. In addition, the sixth position-limiting portion M6 in a movement path of the eighth position-limiting portion M8, and vice versa. In this way, as illustrated in FIG. 4C, when the first rotating shaft A11 and the first axle hole H11, the second rotating shaft A2 and the second axle hole H21, the third rotating shaft A3 and the third axle hole H31, the fourth rotating shaft A4 and the fourth axle hole H41 are arranged in a straight line, the first position-limiting portion M1 stops at one side of the third position-limiting portion M3, and the second position-limiting portion M2 stops at one side of the fourth position-limiting portion M4. Therefore, the position-limiting structure provides stopping effect toward the rotating shaft and the torque member, so that only one direction of pivoting thereof is remained. The position-limiting portion on the right side of FIG. 4B also provides the same effect, and may not be repeated herein.

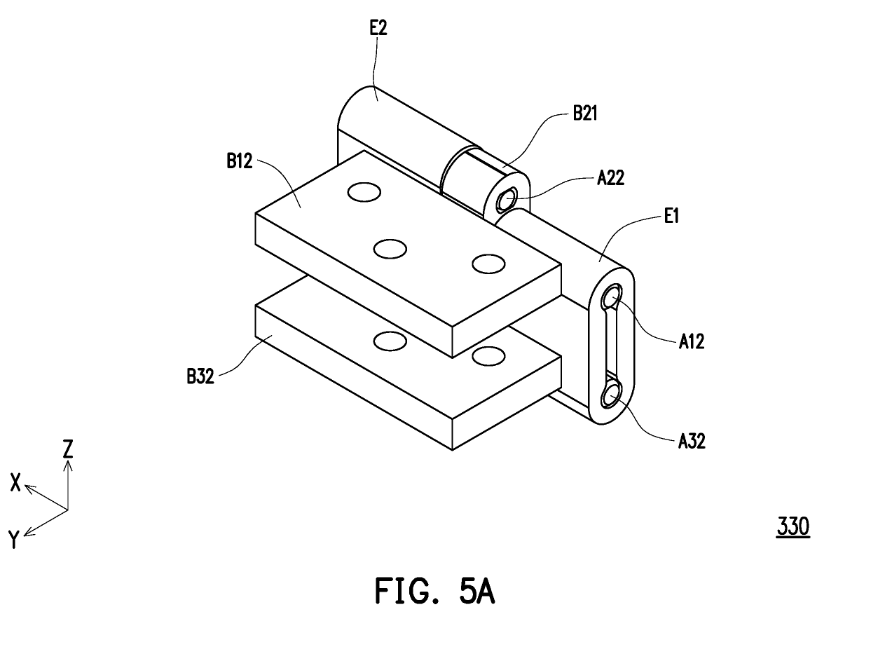

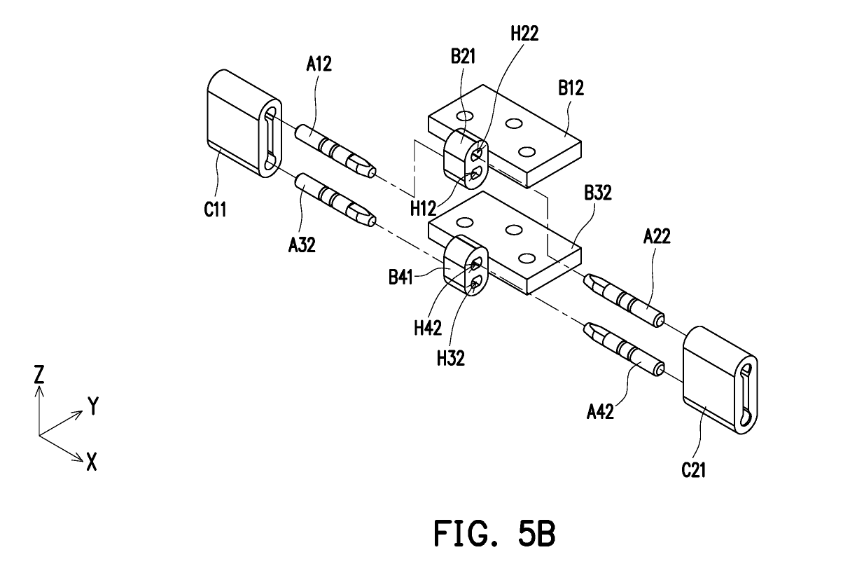

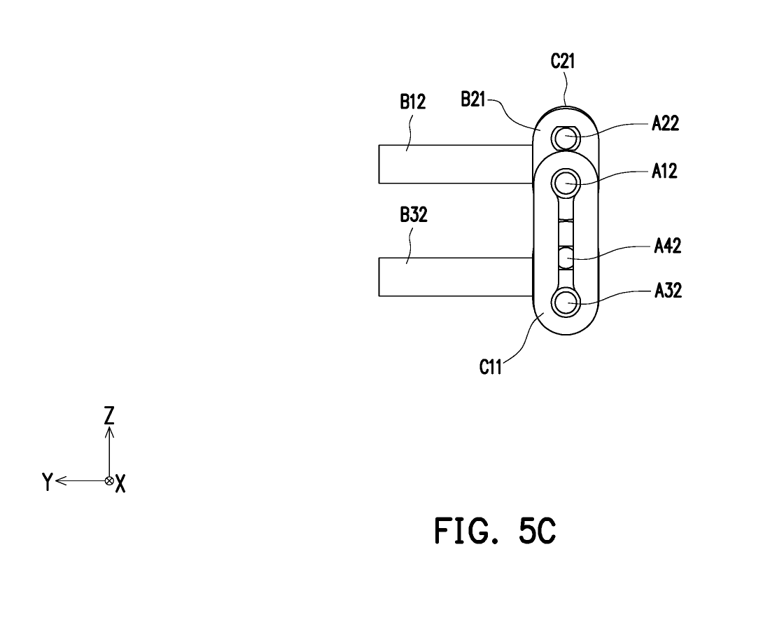

FIG. 5A is a schematic diagram of an electronic device according to another embodiment of the invention. FIG. 5B is an exploded view of the multiaxial hinge module of FIG. 5A. FIG. 5C is a side view of the multiaxial hinge module of FIG. 5A. Please refer to FIG. 5A to FIG. 5C at the same time. In the multiaxial hinge module 330 of this embodiment, the components of the aforementioned embodiments are simplified, and a first rotating shaft A12 and a second rotating shaft A22 are assembled to a first connecting portion B21 of a first bracket B12 in opposite directions, and a third rotating shaft A32 and a fourth rotating shaft A42 are assembled to a second connecting portion B41 of a second bracket B32 in opposite directions. The interleaving multiaxial parallel mechanism is thus formed by the first rotating shaft A12 and the first axle hole H12, the second rotating shaft A22 and the second axle hole H22, the third rotating shaft A32 and the third axle hole H32, the fourth rotating shaft A42 and the fourth axle hole H42. Moreover, the first torque member C11 is pivoted to the first rotating shaft A12 and the third rotating shaft A32 at the same time, and the second torque member C21 is pivoted to the second rotating shaft A22 and the fourth rotating shaft A42 at the same time so as to complete the multiaxial linking mechanism. At the same time, this embodiment is further different from the above that the first bracket B12 and the second bracket B32 increase their own thickness so as to provide the stop effect while the first rotating shaft A12, the second rotating shaft A22, the third rotating shaft A32, and the fourth rotating shaft A42 being in the straight line, so as to achieve the aforementioned freedom that only one rotation direction is remained for the multiaxial linking mechanism at this time.

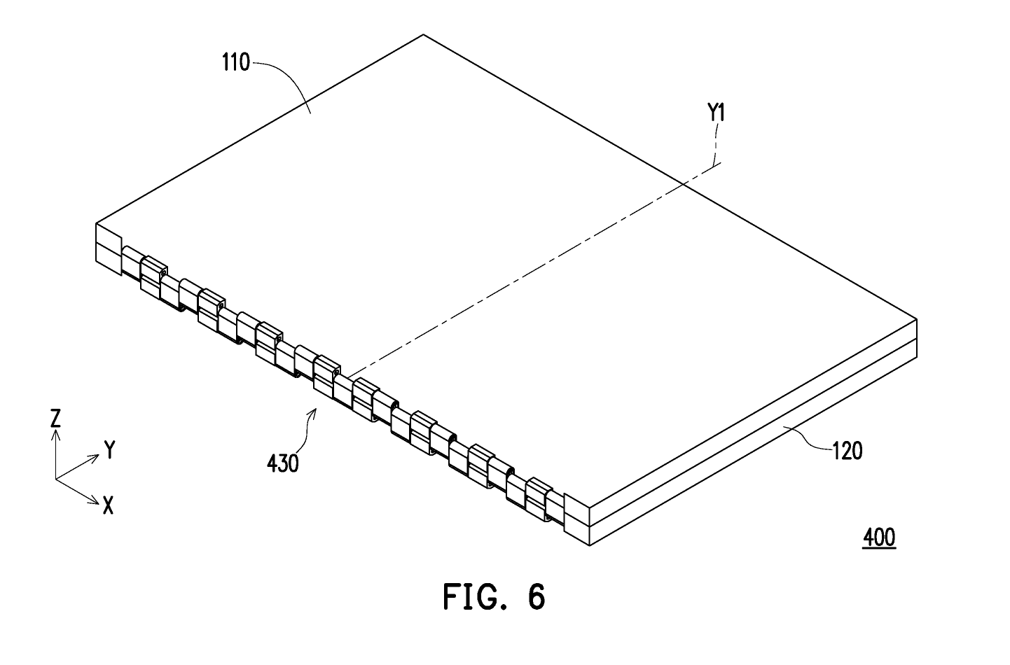

FIG. 6 is a schematic diagram of an electronic device according to another embodiment of the invention. Different from FIG. 1, the electronic device 400 of the embodiment has a plurality of multiaxial hinge modules 430, in which the multiaxial hinge modules 430 are serially connected along the same side of the first body 110 and the second body 120. In addition, the multiaxial hinge modules 430 are in symmetrical configuration relative to a centerline Y1 of the first body 110 and the second body 120. Accordingly, by adding the quantity of the multiaxial hinge modules 430, the risk of stress concentration on a single rotating shaft may be effectively avoided. At the same time, the multiaxial hinge modules 430 and the related components thereof may be further reduced in shape and the electronic device 400 thus has the light and thin appearance. It should be illustrated that the quantity of the multiaxial hinge module connected to the first body 110 and the second body 120 of the aforementioned different embodiments may generally increase as illustrated in FIG. 6.

In view of the above, the multiaxial hinge modules in the aforementioned embodiments of the invention, the plurality of rotating shafts are arranged in a multiaxial parallel manner and are connected to different bodies of the electronic device. The plurality of rotating shafts share the stress load while the bodies being rotated to reduce the stress load applied on single shaft. Furthermore, a portion of the shafts of the multiaxial hinge module are pivoted to a torque member, and another portion of the shafts of the multiaxial hinge module are pivoted to another torque members.

In this way, in terms of the multiaxial hinge module, except of the stress load being dispersed via the different torque members while the multiaxial hinge module being rotated, the plurality of rotating shafts are linked to each other by the torque members, and the first body and second body thus successfully being rotated to be folded or unfolded simultaneously. Accordingly, the applied stress load of each of the rotating shafts is lowered, the shape of the rotating shafts and related components thereof are reduced, and the multiaxial hinge module and the electronic device thus have a light and thin appearance.

Furthermore, to avoid the dead position of the multiaxial hinge module when the body is opened/closed, during the rotating and opening/closing of the electronic device, the condition that the rotating shaft is arranged as a straight line only occurs when it is completely closed (in 0 degree state) and completely rotated (in 360 degree state). This move effectively prevents the possibility that the rotating and opening/closing process of the electronic device is interrupted.

Although the embodiments are already disclosed as above, these embodiments should not be construed as limitations on the scope of the invention. It will be apparent to those ordinarily skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

1. A multiaxial hinge module, comprising:
a first bracket, having a first axle hole and a second axle hole;
a second bracket, having a third axle hole and a fourth axle hole;
a first rotating shaft, disposed in the first axle hole of the first bracket;
a second rotating shaft, disposed in the second axle hole of the first bracket;
a third rotating shaft, disposed in the third axle hole of the second bracket;
a fourth rotating shaft, disposed in the fourth axle hole of the second bracket, wherein the first rotating shaft and the first axle hole, the second rotating shaft and the second axle hole, the third rotating shaft and the third axle hole, the fourth rotating shaft and the fourth axle hole are arranged in a multiaxial parallel manner;
a first torque member, the first rotating shaft and the third rotating shaft pivoted to the first torque member respectively; and
a second torque member, the second rotating shaft and the fourth rotating shaft pivoted to the second torque member respectively.

2. The multiaxial hinge module according to claim 1, wherein when the first rotating shaft, the second rotating shaft, the third rotating shaft and the fourth rotating shaft are arranged in a straight line, the first bracket stops at least one of the first torque member and the second torque member, the second bracket stops at least one of the second torque member and the first torque member, and each of the first rotating shaft, the second rotating shaft, the third rotating shaft, and the fourth rotating shaft has only one direction to pivot.

3. The multiaxial hinge module according to claim 2, wherein the first bracket and the second bracket stop the corresponding first torque member and the corresponding second torque member in a same direction.

4. The multiaxial hinge module according to claim 3, wherein the direction is orthogonal to the straight line.

5. The multiaxial hinge module according to claim 1, wherein the first bracket has at least one first stopping surface and a first connecting portion, the second bracket has at least one second stopping surface and a second connecting portion, the first rotating shaft and the second rotating shaft are opposite to each other and staggered pivoted to the first axle hole and the second axle hole of the first connecting portion, the third rotating shaft and the fourth rotating shaft are opposite to each other and staggered pivoted to the third axle hole and the fourth axle hole of the second connecting portion, when the first rotating shaft, the second rotating shaft, the third rotating shaft and the fourth rotating shaft are arranged in a straight line, the at least one first stopping surface stops at least one of the first torque member and the second torque member, the at least one second stopping surface stops at least one of the second torque member and the first torque member, and each of the first rotating shaft, the second rotating shaft, the third rotating shaft and the fourth rotating shaft has only one direction to pivot.

6. The multiaxial hinge module according to claim 5, wherein the first bracket has a pair of the first stopping surfaces, located at opposite two sides of the first connecting portion, the second bracket has a pair of second stopping surfaces, located at opposite two sides of the second connecting portion, when the first rotating shaft, the second rotating shaft, the third rotating shaft, and the fourth rotating shaft are arranged in the straight line, the pair of the first stopping surfaces stop the first torque member and the second torque member respectively, the pair of the second stopping surfaces stop the first torque member and the second torque member respectively.

7. The multiaxial hinge module according to claim 1, further comprising a position-limiting structure, wherein when the first rotating shaft, the second rotating shaft, the third rotating shaft and the fourth rotating shaft are arranged in a straight line, the first rotating shaft, the second rotating shaft, the third rotating shaft and the fourth rotating shaft are stopped by the position-limiting structure and each of the first rotating shaft, the second rotating shaft, the third rotating shaft and the fourth rotating shaft has only one direction to pivot, the position-limiting structure comprises:
a first position-limiting member, having a first position-limiting portion and a second position-limiting portion, the first rotating shaft and the third rotating shaft pivoted to the first position-limiting member respectively;
a third position-limiting portion, disposed on the first rotating shaft, and the first position-limiting portion being in a movement path of the third position-limiting portion and vice versa;
a fourth position-limiting portion, disposed on the third rotating shaft, and the second position-limiting portion being in a movement path of the fourth position-limiting portion and vice versa;
a second position-limiting member, having a fifth position-limiting portion and a sixth position-limiting portion, the second rotating shaft and the fourth rotating shaft pivoted to the second position-limiting member respectively;
a seventh position-limiting portion, disposed on the second rotating shaft, and the fifth position-limiting portion being in a movement path of the seventh position-limiting portion and vice versa; and
an eighth position-limiting portion, disposed on the fourth rotating shaft, and the sixth position-limiting portion being in a movement path of the eighth position-limiting portion and vice versa.

8. The multiaxial hinge module according to claim 1, wherein each of the first torque member and the second torque member has different torque portions and a middle portion located between the different torque portions, the middle portion blocks torque transmission between the different torque portions, the first rotating shaft, the second rotating shaft, the third rotating shaft and the fourth rotating shaft are pivoted to the torque portions respectively.

9. The multiaxial hinge module according to claim 8, further comprising:
a first position-limiting member, having a first opening, the middle portion of the first torque member having a first protruding portion to be locked to the first opening, and the first position-limiting member being stacked on the first torque member; and
a second position-limiting member, having a second opening, the middle portion of the second torque member having a second protruding portion to be locked to the second opening, and the second position-limiting member stacked on the second torque member.

10. The multiaxial hinge module according to claim 9, further comprising:
a third position-limiting portion, having at least one third opening, the middle portion of the first torque member further having at least one third protruding portion to be locked to the third opening, and the third position-limiting portion being stacked on the first torque member; and
a fourth position-limiting member, having at least one fourth opening, the middle portion of the second torque member further having at least one fourth protruding portion to be locked to the fourth opening, and the fourth position-limiting member being stacked on the second torque member.

11. The multiaxial hinge module according to claim 10, further comprising:
a first housing, the first position-limiting member and the third position-limiting member held on opposite two sides of the first torque member, the first torque member locked into the first housing by the first position-limiting member and the third position-limiting member; and
a second housing, the second position-limiting member and the fourth position-limiting member held on opposite two sides of the second torque member, the second torque member locked into the second housing by the second position-limiting member and the fourth position-limiting member.

12. An electronic device, comprising:
a first body;
a second body;
at least one multiaxial hinge module, connected to the first body and the second body, the first body and the second body rotating relatively to be folded or unfolded by the at least one multiaxial hinge module, the multiaxial hinge module comprising:
a first bracket, having a first axle hole and a second axle hole;
a second bracket, having a third axle hole and a fourth axle hole;
a first rotating shaft, disposed in the first bracket;
a second rotating shaft, disposed in the first bracket;
a third rotating shaft, disposed in the second bracket;
a fourth rotating shaft, disposed in the second bracket, wherein the first rotating shaft and the first axle hole, the second rotating shaft and the second axle hole, the third rotating shaft and the third axle hole, the fourth rotating shaft and the fourth axle hole are arranged in a multiaxial parallel manner;
a first torque member, the first rotating shaft and the third rotating shaft pivoted to the first torque member respectively; and
a second torque member, the second rotating shaft and the fourth rotating shaft pivoted to the second torque member respectively.

13. The electronic device according to claim 12, comprising a plurality of multiaxial hinge modules, serially connected along a same side of the first body and the second body.

14. The electronic device according to claim 13, wherein the plurality of the multiaxial hinge modules are symmetrically arranged relative to a centerline of the first body and the second body.

15. The electronic device according to claim 12, wherein when the first rotating shaft, the second rotating shaft, the third rotating shaft and the fourth rotating shaft are arranged in a straight line, the first body is stacked on one side of opposite two sides of the second body.

16. The electronic device according to claim 12, wherein when the first rotating shaft, the second rotating shaft, the third rotating shaft, and the fourth rotating shaft are arranged in a straight line, the first bracket stops at least one of the first torque member and the second torque member, the second bracket stops at least one of the second torque member and the first torque member, and each of the first rotating shaft, the second rotating shaft, the third rotating shaft, and the fourth rotating shaft has only one direction to pivot.

17. The electronic device according to claim 16, wherein the first bracket and the second bracket stop the corresponding first torque member and the corresponding second torque member in a same direction.

18. The electronic device according to claim 17, wherein the direction is orthogonal to the straight line.

19. The electronic device according to claim 12, wherein the first bracket has at least one first stopping surface and a first connecting portion, the second bracket has at least one second stopping surface and a second connecting portion, the first rotating shaft and the second rotating shaft are opposite to each other and staggered pivoted to the first axle hole and the second axle hole of the first connecting portion, the third rotating shaft and the fourth rotating shaft are opposite to each other and staggered pivoted to the third axle hole and the fourth axle hole of the second connecting portion, when the first rotating shaft, the second rotating shaft, the third rotating shaft, and the fourth rotating shaft are arranged in a straight line, the at least one first stopping surface stops at least one of the first torque member and the second torque member, the at least one second stopping surface stops at least one of the second torque member and the first torque member, and each of the first rotating shaft, the second rotating shaft, the third rotating shaft and the fourth rotating shaft has only one direction to pivot.

20. The electronic device according to claim 19, wherein the first bracket has a pair of the first stopping surfaces, located at opposite two sides of the first connecting portion, the second bracket has a pair of second stopping surfaces, located at opposite two sides of the second connecting portion, when the first rotating shaft, the second rotating shaft, the third rotating shaft, and the fourth rotating shaft are arranged in the straight line, the pair of the first stopping surfaces stop the first torque member and the second torque member respectively, the pair of the second stopping surfaces stop the first torque member and the second torque member respectively.

21. The electronic device according to claim 12, wherein the multiaxial hinge module further comprises a position-limiting structure, when the first rotating shaft, the second rotating shaft, the third rotating shaft and the fourth rotating shaft are arranged in a straight line, the first rotating shaft, the second rotating shaft, the third rotating shaft and the fourth rotating shaft are stopped by the position-limiting structure and each of the first rotating shaft, the second rotating shaft, the third rotating shaft and the fourth rotating shaft has only one direction to pivot, the position-limiting structure comprises:
a first position-limiting member, having a first position-limiting portion and a second position-limiting portion, the first rotating shaft and the third rotating shaft pivoted to the first position-limiting member respectively;
a third position-limiting portion, disposed on the first rotating shaft, and the first position-limiting portion being in a movement path of the third position-limiting portion and vice versa;
a fourth position-limiting portion, disposed on the third rotating shaft, and the second position-limiting portion being in a movement path of the fourth position-limiting portion and vice versa;
a second position-limiting member, having a fifth position-limiting portion and a sixth position-limiting portion, the second rotating shaft and the fourth rotating shaft pivoted to the second position-limiting member respectively;
a seventh position-limiting portion, disposed on the second rotating shaft, and the fifth position-limiting portion being in a movement path of the seventh position-limiting portion and vice versa; and
an eighth position-limiting portion, disposed on the fourth rotating shaft, and the sixth position-limiting portion being in a movement path of the eighth position-limiting portion and vice versa.

22. The electronic device according to claim 12, wherein each of the first torque member and the second torque member has different torque portions and a middle portion located between the different torque portions, the middle portion blocks torque transmission between the different torque portions, the first rotating shaft, the second rotating shaft, the third rotating shaft and the fourth rotating shaft are pivoted to the torque portions respectively.

23. The electronic device according to claim 22, wherein the multiaxial hinge module further comprising:
a first position-limiting member, having a first opening, the middle portion of the first torque member having a first protruding portion to be locked to the first opening, and the first position-limiting member being stacked on the first torque member; and
a second position-limiting member, having a second opening, the middle portion of the second torque member having a second protruding portion to be locked to the second opening, and the second position-limiting member being stacked on the second torque member.

24. The electronic device according to claim 23, wherein the multiaxial hinge module further comprising:
a third position-limiting portion, having at least one third opening, the middle portion of the first torque member further having at least one third protruding portion to be locked to the third opening, and the third position-limiting portion being stacked on the first torque member; and
a fourth position-limiting member, having at least one fourth opening, the middle portion of the second torque member further having at least one fourth protruding portion to be locked to the fourth opening, and the fourth position-limiting member being stacked on the second torque member.

25. The electronic device according to claim 24, wherein the multiaxial hinge module further comprising:
a first housing, the first position-limiting member and the third position-limiting member held on opposite two sides of the first torque member, the first torque member locked into the first housing by the first position-limiting member and the third position-limiting member; and
a second housing, the second position-limiting member and the fourth position-limiting member held on opposite two sides of the second torque member, the second torque member locked into the second housing by the second position-limiting member and the fourth position-limiting member.
